(19) United States
(12) Patent Application Publication
(10) Pub. No.: US 2025/0138780 A1
(43) Pub. Date: May 1, 2025

(54) Addition Tree Computation Device, Method and Computation Device

(71) Applicant: Shenzhen Corerain Technologies Co., Ltd., Shenzhen (CN)

(72) Inventors: Chenchen Lu, Shenzhen (CN); Kuen Hung Tsoi, Shenzhen (CN); Xinyu Niu, Shenzhen (CN)

(21) Appl. No.: 18/650,150

(22) Filed: Apr. 30, 2024

(30) Foreign Application Priority Data
Oct. 27, 2023 (CN) 202311408926.X

(51) Int. Cl. G06F 7/50; G06F 5/01

(52) U.S. Cl. CPC G06F 7/50; G06F 5/01

(57) ABSTRACT

The present application provides an addition tree computation device, method and computation device for the addition operation of floating-point numbers and fixed-point numbers. The data input module receives input data and calculation type instructions; the transmission control module controls the first multiplexer, according to the calculation type instructions, to send floating-point numbers to the first entrance of the fusion calculation module, or to send fixed-point numbers to the second entrance of the fusion calculation module; the fusion calculation module is used to perform addition operations, and the data normalization output module performs output processing on the operation results according to the control of the transmission control module, and outputs the final calculation results. Through the modification and design of the fixed-point number addition tree chip circuit, high-speed and high-precision addition operations for two data types including floating-point and fixed-point numbers are realized.

### CROSS REFERENCE TO RELATED APPLICATIONS

The present application claims the benefit of Chinese Patent Application No. 202311408926.X filed on Oct. 27, 2023, the contents of which are incorporated herein by reference in their entirety.

### TECHNICAL FIELD

The present invention relates to the field of chip circuit technology, and in particular to an addition tree computation device, method and computation device.

### BACKGROUND TECHNIQUE

With the rapid advancement of artificial intelligence technology, algorithms like convolutional neural networks and transformers have found widespread application in various fields, including machine vision and large language models. However, artificial intelligence algorithms like convolutional neural networks and transformers contain numerous floating-point or fixed-point number multiplication and accumulation operations. If these operations are run on the CPU, they will consume significant computation time. Especially for some application fields with high real-time requirements (such as in-vehicle autonomous driving), if the computation time is too long, it will hinder the deployment of artificial intelligence algorithms in daily applications. As a result, specialized chips like GPUs and Google TPUs have emerged in recent years to specifically accelerate AI algorithm calculations. Because algorithms like convolutional neural networks and transformers contain numerous floating-point or fixed-point number multiplication and accumulation operations, how to enhance the speed of multiplication and accumulation operations for floating-point or fixed-point numbers has become a significant topic in the design process of artificial intelligence-specific chips.

In chip circuit design, methods to improve the speed of multiplication and accumulation of floating-point or fixed-point numbers include increasing the clock frequency of the arithmetic circuit, improving the parallelism of the arithmetic circuit, improving the pipeline level of the arithmetic circuit, etc. Among them, the method to improve the parallelism of the arithmetic circuit involves instantiating numerous multipliers, adders, and other computation units to perform multiplication and accumulation operations simultaneously. When the calculation results from multiple multipliers need to be added together, an addition tree circuit is employed.

The traditional addition tree is limited to performing addition operations on a single data type. When it comes to fixed-point number addition trees, the data undergoes addition through multiple stages of adders to arrive at the final result. In contrast, floating-point number addition trees are relatively more intricate. These trees consist of floating-point number adders, whose structure is quite complex. Compared to fixed-point number adders, floating-point number adders involve additional complex operations such as exponent comparison and exponent shifting. This processing is required before each adder at each level performs its addition operations, making the entire process quite cumbersome and intricate.

In addition to the intricate data processing, when utilizing the traditional floating-point number addition tree to perform pairwise addition of floating-point data, it becomes necessary to perform shifting operations based on the exponent difference between the two floating-point numbers. If swapping the positions of the floating-point data, it may result in different calculation results. For example, assuming that four floating-point numbers being added: 0.987, 1.23, 12.3, and 123, the mantissa bit width of the floating-point numbers is 3 bits, and the bit width of the adder for mantissa addition is 3 bits, the calculated result is 137, when the floating-point numbers are added in the order of 0.987, 1.23, 12.3, and 123. However, if the addition operation is performed in the order of 0.987, 123, 1.23, and 12.3, the calculated result is 136. It is obvious that such cumbersome calculation steps not only fail to guarantee the accuracy and speed of the addition operation but also consume additional computer resources.

For this reason, a technical solution is needed that can improve the accuracy of the addition tree operation while simplifying the operation process and increasing the operation speed.

### CONTENTS OF THE INVENTION

The purpose of the present application is to provide an addition tree computation device and method and computation device. Through the modification and design of the fixed-point number addition tree chip circuit, high-speed and high-precision addition operations for two data types including floating-point and fixed-point numbers are realized.

According to an aspect of the present application, an addition tree computation device is provided, used for an addition operation of floating-point numbers and fixed-point numbers, the addition tree computation device includes a data input module, a first multiplexer, a transmission control module, a fusion calculation module, and a data normalization output module; the fusion calculation module has a first entrance and a second entrance, wherein:
the data input module receives an input data and a calculation type instruction;
the transmission control module controls the first multiplexer according to the calculation type instruction to send a floating-point number to the first entrance of the fusion calculation module, or to send a fixed-point number to the second entrance of the fusion calculation module;
the fusion calculation module is used to perform a fixed-point number addition operation and a floating-point number addition operation, and output an operation result to the data normalization output module; and
the transmission control module controls the data normalization output module to perform an output processing on the operation result according to the calculation type instruction, and outputs a final calculation result.

According to some embodiments, the fusion calculation module includes a preprocessing module, a second multiplexer and a fixed-point addition tree module, wherein:
the preprocessing module receives the floating-point number through the first entrance and sends a preprocessing result to the second multiplexer;
the second multiplexer receives the fixed-point number from the first multiplexer through the second entrance, and outputs the fixed-point number or the preprocessing result according to control of the transmission control module; and
the fixed-point addition tree module receives the output of the second multiplexer to perform a fixed-point addition operation.

According to some embodiments, the preprocessing module includes an exponent difference module, a mantissa alignment module and an exponent register array, wherein:
the exponent difference module is used to calculate an exponent difference between an input floating-point number and a floating-point number reference exponent;
the mantissa alignment module applies a calculated exponent difference to shift a mantissa of the floating-point number;
the exponent register array is used to store the floating-point number reference exponent, the floating-point number reference exponent is obtained by performing an exponent comparison on the input floating-point number through the exponent difference module or is preset.

According to some embodiments, the data normalization output module includes: a third multiplexer, a normalization processing unit, and a fourth multiplexer, wherein:
the third multiplexer sends the operation result of the fusion calculation module to the normalization processing unit or the fourth multiplexer according to the control of the transmission control module;
the normalization processing unit is used to perform a normalization operation on an input operation result according to a floating-point number specification, and send a normalized result data to the fourth multiplexer;
the fourth multiplexer outputs the final calculation result according to the control of the transmission control module.

According to some embodiments, the normalization processing unit is configured to:
read the floating-point number reference exponent stored in the exponent register array, perform data normalization and rounding processing on a floating-point addition operation result, and output the floating-point number that meets the specification.

According to another aspect of the present application, a method for an addition tree computation device is provided to implement an addition operation of floating-point numbers and fixed-point numbers, the method includes:
receiving an input data which is a fixed-point number or a floating-point number;
sending the floating-point number to a first calculation channel;
sending a fixed-point number data to a second calculation channel;
performing a fixed-point addition operation on the input data from the first calculation channel or the second calculation channel; and
performing an output processing on an operation result according to a data type.

According to some embodiments, the step of sending the floating-point number to a first calculation channel further includes:
for an input floating-point number, calculating an exponent difference of each floating-point number according to a floating-point number reference exponent which is obtained by performing an exponent comparison on the input floating-point number or is preset;
shifting a mantissa of the floating-point number according to the exponent difference of each floating-point number.

According to some embodiments, the step of performing a fixed-point addition operation on the input data from the first calculation channel or the second calculation channel includes:
receiving the floating-point number and/or the fixed-point number after the mantissa is shifted and sending the floating-point number and/or the fixed-point number to a fixed-point addition tree;
using the fixed-point addition tree to perform the addition operation to obtain the operation result.

According to some embodiments, the step of performing an output processing on an operation result according to a data type includes:
in response to the operation result being the floating-point number, performing a normalization processing on the operation result to output a normalized result data as a final calculation result;
in response to the operation result being the fixed-point number data, outputting the operation result as the final calculation result.

According to another aspect of the present application, a chip circuit is provided to implement the above apparatus.

According to another aspect of the present application, a computation device is provided, including:
a processor; and
a memory storing a computer program that, when executed by the processor, causes the processor to execute any one of the above methods.

According to another aspect of the present application, a non-transitory computer-readable storage medium is provided, on which computer-readable instructions are stored, when the instructions are executed by a processor, causing the processor to perform any of the above methods.

According to the embodiments of the present application, by separately processing two distinct types of input data through individual channels, the application of complex floating-point addition calculations is achieved through the integration and modification of the fixed-point addition tree chip circuit. This not only facilitates the fusion operation of the addition tree for various data types but also circumvents the issues of calculation accuracy and operation speed that arise from repeatedly rearranging the order of floating-point data addition. In essence, the simplified addition tree chip circuit is utilized to perform high-precision, high-speed addition operations across multiple data types.

It should be understood that the above general description and the following detailed description are only exemplary and do not limit the present application.

### DESCRIPTION OF THE DRAWINGS

In order to explain the technical solutions in the embodiments of the present application more clearly, the drawings needed to be used in the description of the embodiments will be briefly described below.

FIG. 1 shows a structural schematic diagram of an apparatus for an addition tree calculation according to an exemplary embodiment.

FIG. 2 shows a structural schematic diagram of a module for fusion calculation according to an exemplary embodiment.

FIG. 3 shows a structural schematic diagram of a preprocessing module according to an exemplary embodiment.

FIG. 4 shows a structural schematic diagram of a data normalization output module according to an exemplary embodiment.

FIG. 5 shows a structural schematic diagram of an addition tree computation device according to another exemplary embodiment.

FIG. 6 shows a method flowchart of an addition tree computation device according to an exemplary embodiment.

FIG. 7 illustrates a block diagram of a computation device according to an exemplary embodiment.

### DETAILED DESCRIPTION

Exemplary embodiments will now be described more fully with reference to the accompanying drawings. However, exemplary embodiments may be embodied in various forms and should not be construed as being limited to the embodiments described herein. Instead, these embodiments are provided so that this disclosure will be thorough and complete, and will fully convey the concepts of the exemplary embodiments to those skilled in the art. The same figures shown in the drawings represent the same or similar parts, and thus their repeated description will be omitted.

Furthermore, the described features, structures or characteristics may be combined in any suitable manner in one or more embodiments. In the following description, many specific details are provided to give a thorough understanding of embodiments of the present application. The technical solutions presented in this application may be practiced without some of the specific details or may utilize alternative methods, components, devices, steps, and so on, as those skilled in the art will recognize. In other cases, commonly known methods, apparatuses, implementations, or operations have been omitted or described briefly to prevent obscuring the core aspects of the present application.

The block diagrams shown in the drawings are functional entities only and do not necessarily correspond to physically independent entities. That is, these functional entities may be implemented in software form, or implemented in one or more hardware modules or integrated circuits, or implemented in different networks and/or processor devices and/or microcontroller devices.

The flowcharts shown in the drawings are only illustrative, and do not necessarily include all contents and operations/steps, nor must they be performed in the order described. For example, some operations/steps can be decomposed, and some operations/steps can be merged or partially merged, so the actual order of execution may change according to the actual situation.

It should be understood that although terms such as “first”, “second”, and “third” may be used in this disclosure to describe various components, these components should not be limited by these terms. These terms are used to distinguish one component from another. Therefore, the first component discussed below may be referred to as the second component without deviating from the teachings of the present application. As used herein, the term “and/or” includes any and all combinations of one or more of the associated listed items.

The user information (including but not limited to user device information, user personal information, etc.) and data (including but not limited to data used for analysis, stored data, displayed data, etc.) involved in the present application are information and data that have been authorized by users or fully authorized by all parties. The collection, use, and processing of relevant data need to comply with relevant laws, regulations, and standards in relevant countries and regions, and provide corresponding operation entrances for users to choose to authorize or refuse.

It is understood by those skilled in the art that the accompanying drawings are only schematic diagrams of exemplary embodiments, and the modules or processes depicted in the drawings are not necessarily essential for implementing the present application. Therefore, they cannot be used to limit the scope of protection of the present application.

With the rapid advancement of artificial intelligence technology, algorithms like convolutional neural networks and transformers have found widespread application in various fields, including machine vision and large language models. However, artificial intelligence algorithms like convolutional neural networks and transformers contain numerous floating-point or fixed-point number multiplication and accumulation operations. If these operations are run on the CPU, they will consume significant computation time. Especially for some application fields with high real-time requirements (such as in-vehicle autonomous driving), if the computation time is too long, it will hinder the deployment of artificial intelligence algorithms in daily applications. Therefore, in recent years, enhancing the speed of multiplication and accumulation operations for floating-point or fixed-point numbers has become a significant topic in the design process of artificial intelligence-specific chips. In chip circuit design, addition tree circuits are typically used to perform high-speed addition operations

The traditional addition tree is limited to performing addition operations on a single data type. When it comes to fixed-point number addition trees, the data undergoes addition through multiple stages of adders to arrive at the final result. In contrast, floating-point number addition trees are relatively more intricate. These trees consist of floating-point number adders, whose structure is quite complex. Compared to fixed-point number adders, floating-point number adders involve additional complex operations such as exponent comparison and exponent shifting. This processing, which is done before each adder at every level performs addition operations, is quite cumbersome and complex. It not only makes it challenging to enhance the calculation speed, but also consumes a significant amount of computer resources.

In addition to the intricate data processing, when utilizing the traditional floating-point number addition tree to perform pairwise addition of floating-point data, it becomes necessary to perform shifting operations based on the exponent difference between the two floating-point numbers. This process swapping the positions of the floating-point data, which could lead to varying calculation results. This makes it challenging to ensure the accuracy of the addition operation.

To this end, the present application proposes an addition tree computation device and method and computation device. Through the modification and design of the fixed-point number addition tree chip circuit, high-speed and high-precision addition operations for two data types including floating-point and fixed-point numbers are realized. According to some embodiments, the addition tree computation device of the present invention sends the input floating-point numbers into the designed first floating-point number calculation channel. In this channel, the mantissa of multiple floating-point numbers is shifted with reference to the floating-point number reference exponent, the floating-point number reference exponent is saved, and the mantissa is sent to the fixed-point addition tree module for addition operation, and then the output results are normalized to improve the calculation accuracy and speed. For fixed-point number data, they are directly sent to the fixed-point number addition tree through the second calculation channel, realizing the integrated and high-speed calculation of multiple data types in the same addition tree.

Exemplary embodiments of the present application are described below with reference to the accompanying drawings.

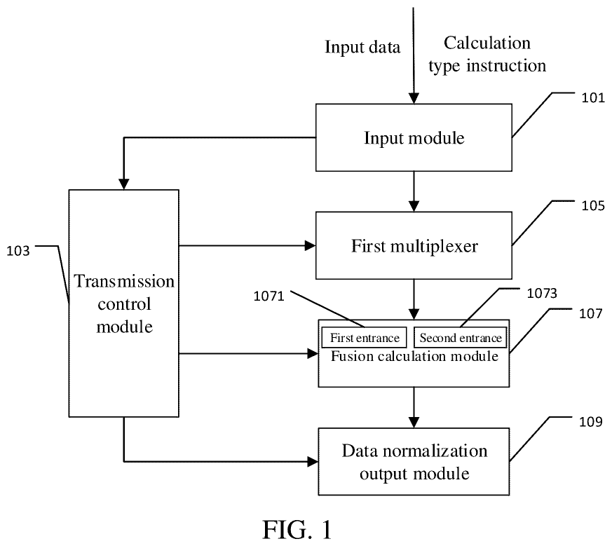

FIG. 1 shows a structural schematic diagram of an apparatus for an addition tree calculation according to an exemplary embodiment.

As shown in FIG. 1, an addition tree computation device according to an exemplary embodiment is used for addition operations of floating-point and fixed-point numbers. The addition tree computation device includes a data input module 101, a first multiplexer 105, a transmission control module 103, a fusion calculation module 107, and a data normalization output module 109. The fusion calculation module 107 has a first entrance 1071 and a second entrance 1073.

The data input module 101 receives input data and calculation type instructions.

According to some embodiments, the data input module is configured to receive input data from a user or other programs. The calculation type instruction is a data type convention statement or operation code that describes the input data. For example, “f” can be used as the calculation type instruction, which means that the calculation type is floating-point number operation.

The transmission control module 103 controls the first multiplexer 105 to send floating-point numbers to the first entrance 1071 of the fusion calculation module 107 according to the calculation type instruction, or to send fixed-point numbers to the second entrance 1073 of the fusion calculation module 107.

According to some embodiments, after receiving the calculation type instruction from the data input 101, the transmission control module 103 outputs a control instruction to the first multiplexer 105 according to the calculation type instruction. The first multiplexer 105 sends the input data to the fusion calculation module 107 according to the calculation type instruction. When the calculation type instruction is a floating-point number operation instruction, the input data is sent to the first entrance 1071 of the fusion calculation module 107; and when the calculation type instruction is a fixed-point number operation instruction, the fixed-point number is sent to the second entrance 1073 of the fusion calculation module 107.

The fusion calculation module 107 is used to perform fixed-point and floating-point number addition operations, and output the operation results to the data normalization output module 109.

According to some embodiments, the fusion calculation module 107 includes a fixed-point number addition module for performing addition operations on input fixed-point number data or floating-point numbers, and outputting result data. The data normalization output module 109 performs data normalization processing on the result data, and then outputs the data that meets the requirements as the final result.

The transmission control module 103 controls the data normalization output module 109 to perform output processing on the output results according to the calculation type instructions, and outputs the final calculation results.

According to some embodiments, the data normalization output module 109 performs output processing on the output results according to the control of the transmission control module 103, and outputs the final calculation result. For example, when the control instruction or control signal is used for fixed-point number calculation, then the operation result of the fixed-point number addition tree module can be output as the final calculation result.

According to some embodiments, the data normalization output module 109 is mainly used for normalization processing of floating-point number addition operation results, and determines whether the processed results meet floating-point number specifications.

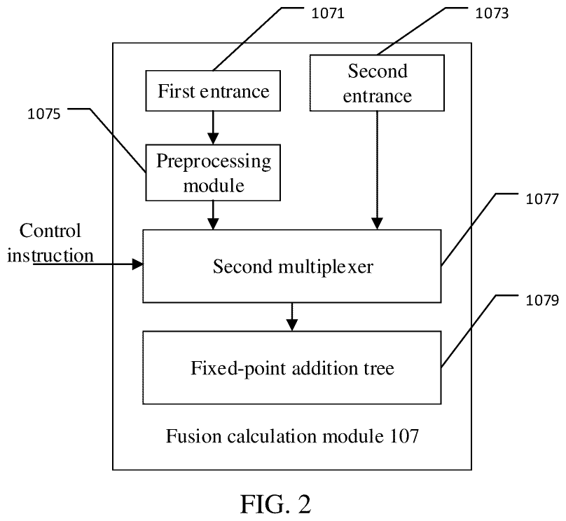

FIG. 2 shows a structural schematic diagram of a module for fusion calculation according to an exemplary embodiment.

Referring to FIG. 2, the fusion calculation module 107 has a first entrance 1071 and a second entrance 1073 according to an exemplary embodiment. The fusion calculation module 107 also includes a preprocessing module 1075, a second multiplexer 1077, and a fixed-point addition tree module 1079.

The preprocessing module 1075 receives the floating-point number through the first entrance 1071 and sends the preprocessed result to the second multiplexer 1077.

According to some embodiments, the preprocessing module 1075 is used to preprocess floating-point number data. The floating-point numbers are input into the preprocessing module 1075 through the first entrance 1071. The floating-point numbers are pre-processed in the preprocessing module 1075, and the processed results are output to the second multiplexer 1077.

According to some embodiments, the preprocessing operation on floating-point numbers in the preprocessing module 1075 includes applying a floating-point number reference exponent to perform exponent difference calculation on the input floating-point number, and applying the calculated exponent difference to shift and align the mantissas of the floating-point numbers.

According to some embodiments, the multiplexer 1077 receives the floating-point number mantissa from the preprocessing module 1075 and sends the floating-point number mantissa into the fixed-point addition tree 1079 for addition operation.

The second multiplexer 1077 receives the fixed-point number from the first multiplexer 105 through the second entrance 1073, and outputs the fixed-point number or the preprocessed results according to the control of the transmission control module 103.

According to some embodiments, the first multiplexer 105 sends fixed-point number data into the second multiplexer 1077 through the second entrance 1073, and the second multiplexer 1077 outputs the fixed-point number data or the preprocessed result to the fixed-point addition tree for addition operation according to the control of the transmission control module 103.

The fixed-point addition tree 1079 receives the output of the second multiplexer 1077 to perform fixed-point addition operations.

According to some embodiments, the fixed-point addition tree 1079 receives the fixed-point number data or the preprocessed result output from the second multiplexer 1077 as input data, performs fixed-point addition operations on the input data, and outputs the operation result.

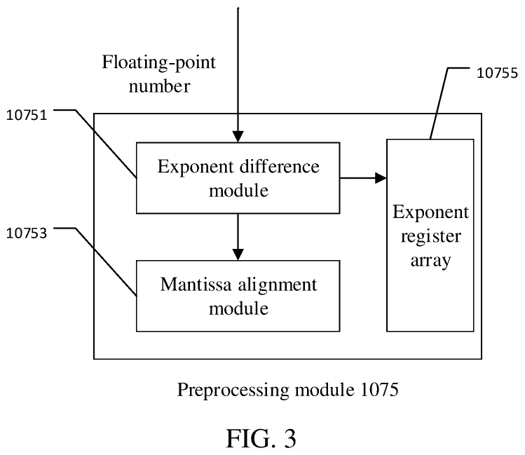

FIG. 3 shows a structural schematic diagram of a preprocessing module according to an exemplary embodiment.

As shown in FIG. 3, the preprocessing module 1075 according to an exemplary embodiment includes an exponent difference module 10751, a mantissa alignment module 10753, and an exponent register array 10755.

The exponent difference module is used to calculate the exponent difference between the input floating-point number and the floating-point number reference exponent.

According to some embodiments, floating-point numbers are input into the exponent difference module 10751 in the preprocessing module 1075 through the first entrance 1071. In the exponent difference module 10751, the exponent comparison is performed on multiple floating-point numbers. The comparison result is used as the floating-point number reference exponent, and the floating-point number reference exponent is sent to the exponent register array 10755 for storage. The floating-point number reference exponent is used to calculate the exponent difference of each floating-point number to obtain the exponent difference of each floating-point number.

The mantissa alignment module 10753 applies the calculated exponent difference to perform mantissa shift on the floating-point number.

According to some embodiments, in the mantissa alignment module 10753, the calculated exponent difference is applied to perform a mantissa shift on each floating-point number to ensure that the mantissas of each input floating-point number are aligned to facilitate subsequent calculations.

According to some embodiments, the floating-point reference exponent can be determined by comparing multiple floating-point data and selecting the maximum exponent, the minimum exponent, the average exponent, etc., as the floating-point number reference exponent according to the requirements of calculation accuracy. Alternatively, a fixed exponent can be set as the floating-point number reference exponent for calculation according to the actual calculation requirements of the user. The set or determined floating-point number reference exponent is then stored in the exponent register array 10755 for subsequent use.

The exponent register array 10755 is used to store the floating-point number reference exponent, which can be obtained by performing exponent comparison on the input floating-point numbers or is preset.

According to some embodiments, a unified floating-point number reference exponent is determined through exponent comparison or set, and unified mantissa shift is performed with reference to the floating-point number reference exponent. This eliminates the need for shift operations before each operation in the addition tree and avoids precision loss due to different orders of accumulation operations. It not only improves the operation speed but also enhances the accuracy of addition operations. Moreover, the floating-point numbers with aligned mantissas after unifying the exponents can adopt a simpler and faster fixed-point number addition tree for addition operations, instead of relying on complex floating-point number adders. This greatly improves the operational efficiency and reduces the resource utilization of the computer.

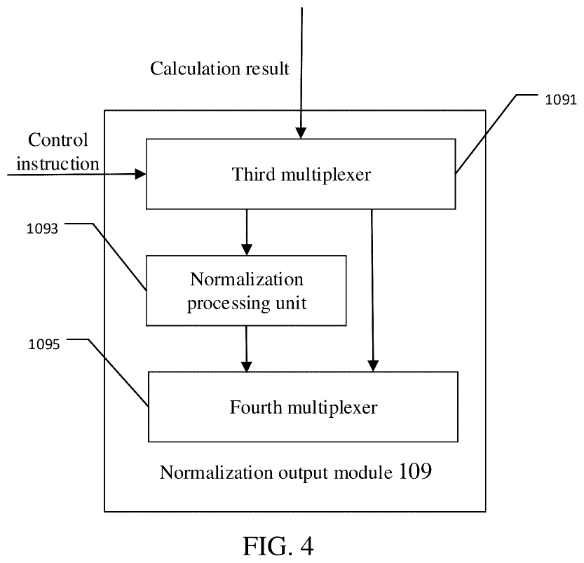

FIG. 4 shows a structural schematic diagram of a data normalization output module according to an exemplary embodiment.

As shown in FIG. 4, the data normalization output module 109 according to an exemplary embodiment includes: a third multiplexer 1091, a normalization processing unit 1093, and a fourth multiplexer 1095.

The third multiplexer 1091 sends the operation result of the fusion calculation module 107 to the normalization processing unit 1093 or the fourth multiplexer 1095 according to the control of the transmission control module 103.

According to some embodiments, the third multiplexer 1091 sends the operation result of the fusion calculation module 107 to the normalization processing unit 1093 or the fourth multiplexer 1095 according to the control of the transmission control module 103. For example, when the instruction is a floating-point number operation instruction, the operation result is sent to the normalization processing unit 1093 for normalization processing.

The normalization processing unit 1093 is configured to perform a normalization operation on the input operation results according to floating-point number specifications, and send the normalized result data to the fourth multiplexer 1095.

The normalization processing unit 1093 is configured to: read the floating-point number reference exponent stored in the exponent register array 10755, perform data normalization operations and rounding processing on the floating-point addition operation results, and output floating-point numbers that meet the specifications.

According to some embodiments, the normalization processing unit 1093 is used to normalize the input operation results according to floating-point number specifications. The normalization processing unit 1093 reads the floating-point number reference exponent stored in the exponent register array. After the normalization process, the processed result data is verified and judged to determine whether the normalized result data meets the normalization standard of floating-point numbers. If it does not meet the standard, re-normalize it until the normalized result data meets the standards. The normalization processing unit 1093 transmits the result data that meets the normalization standard into the fourth multiplexer 1095.

According to some embodiments, the normalization processing unit 1093 can perform a rounding operation on floating-point numbers that meet the standard as required, and then transmit the rounded result data that meets the normalization standard into the fourth multiplexer 1095.

The fourth multiplexer 1095 outputs the final calculation result according to the control of the transmission control module 103.

According to some embodiments, the fourth multiplexer 1095 outputs the final calculation result according to the control of the transmission control module 103.

According to some embodiments, in the normalization processing module 109, the operation results from the fixed-point addition tree module 1079 are normalized. Normalizing the results of floating-point number operations can ensure the correctness of the output results. For fixed-point number operation results, the result data can also be rounded in the normalization module according to preset or specific application scenario requirements. The specific processing method can be determined by the application scenario and accuracy requirements. In the present invention, the result data obtained is only normalized after the operation is completed, instead of normalizing the data at each level of the addition tree. This avoids the error caused by the normalization of each level of the addition tree and improves the accuracy.

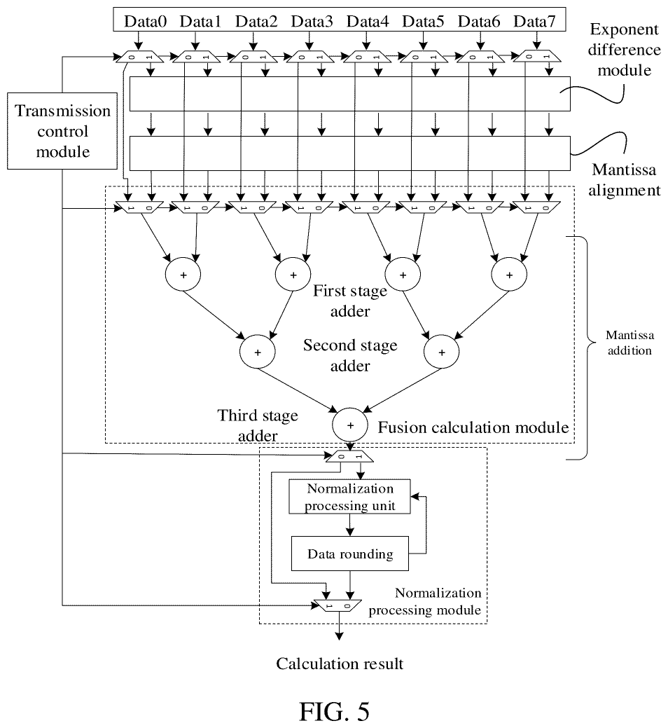

FIG. 5 shows a structural schematic diagram of an addition tree computation device according to another exemplary embodiment.

According to another exemplary embodiment, as shown in FIG. 5, in addition to the various modules and related data processing devices introduced in the above description, the application of the fusion calculation module shown in this example includes a fixed-point addition tree structure of a three-stage fixed-point adder, which can meet the needs of the addition operation of 8 input data in the example.

According to some embodiments, the fixed-point addition tree structure can adjust the number and number of stages of adders in the fixed-point addition tree to meet the needs according to the scale of data that needs to be processed, thereby meeting the data processing requirements and improving the operation speed.

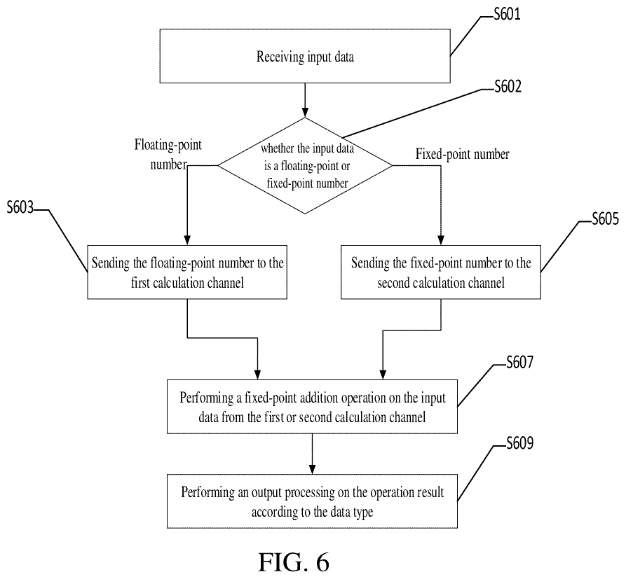

FIG. 6 shows a method flowchart of an addition tree computation device according to an exemplary embodiment.

According to an exemplary embodiment, as shown in FIG. 6, a method for an addition tree computation device to implement the addition operation of floating-point and fixed-point numbers, and the method includes the following steps:
at S601, input data is received.

According to some embodiments, external input data is received, and the input type of the input data may be a fixed-point number or a floating-point number.

In S602, the input data is processed in different channels according to whether the input data is a floating-point number or a fixed-point number.

According to some embodiments, depending on the data type of the received input data, the floating-point number is sent to the first calculation channel, and the fixed-point number is sent to the second calculation channel.

In S603, the floating-point number is sent to the first calculation channel.

The exponent difference of each floating-point number is calculated according to the floating-point number reference exponent for the input floating-point number, and a mantissa shift is performed on the floating-point number according to the exponent difference of each floating-point number.

According to some embodiments, the first calculation channel is used for processing floating-point numbers, and the input floating-point numbers are sent to the first calculation channel for data preprocessing. The preprocessed data is sent into the fixed-point addition tree.

According to some embodiments, the data preprocessing includes performing exponent comparison on each floating-point number to determine a floating-point number reference exponent. The floating-point number reference exponent can be obtained by performing exponent comparison on the input floating-point number or is preset. The exponent difference of each floating-point number is calculated for the input floating-point number according to the floating-point number reference exponent, the calculated exponent difference is used to perform mantissa shift alignment on each floating-point number, and send the aligned floating-point number mantissa to the fixed-point addition tree.

In S605, the fixed-point number data is sent to the second calculation channel.

According to some embodiments, the input fixed-point number data is sent to a second calculation channel, and the fixed-point number input data is sent to a fixed-point addition tree through the second calculation channel.

In S607, a fixed-point addition operation is performed on the input data from the first or second calculation channel.

The floating-point number and/or the fixed-point number with the mantissa shifted are received and sent to a fixed-point addition tree, and the fixed-point addition tree is used to perform an addition operation to obtain an operation result.

According to some embodiments, for the preprocessed floating-point numbers from the first calculation channel or the fixed-point data from the second calculation channel, an addition operation is performed in the fixed-point addition tree, and the operation result is output.

In S609, the operation result is output according to the data type.

According to some embodiments, the operation result is output according to the data type. If the data type is floating-point number, the operation result is normalized and the normalized result data is output as the final calculation result; if the data type is fixed-point number data, the operation result is output as the final calculation result.

According to some embodiments, normalizing the operation results can round the output data according to actual scene and accuracy requirements, and the rounded result is output as the final calculation result.

According to some embodiments, the addition tree computation device of the present invention realizes the integrated addition operation of fixed-point and floating-point numbers while simplifying the chip circuit by modifying and designing the traditional fixed-point addition tree chip circuit.

According to some embodiments, the addition tree computation device of the present invention has a simpler structure than a traditional floating-point number addition tree, occupies less computer resources, and makes data calculations faster.

According to some embodiments, the method of the addition tree computation device of the present invention unifies the exponents of floating-point numbers through a one-time data preprocessing. Then, it aligns the mantissas by shifting, sends them to the fixed-point addition tree for mantissa addition operation, and restore the floating-point numbers through normalization processing. This method avoids the precision loss caused by multiple rounding and adjustments to the order of addition operations in the traditional floating-point number addition tree operation process. By doing so, it achieves both high operational speed and improved data accuracy.

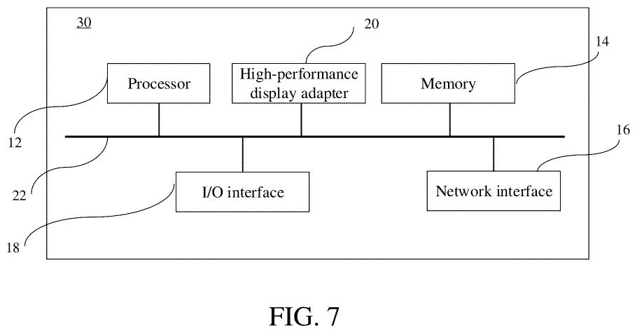

FIG. 7 illustrates a block diagram of a computation device according to an exemplary embodiment of the present application.

As shown in FIG. 7, computation device 30 includes processor 12 and memory 14. computation device 30 may also include bus 22, network interface 16, and I/O interface 18. Processor 12, memory 14, network interface 16, and I/O interface 18 may communicate with each other via bus 22.

The processor 12 may include one or more general-purpose CPUs (Central Processing Units, processors), microprocessors, or application-specific integrated circuits, etc., for executing relevant program instructions. According to some embodiments, computation device 30 may also include a high-performance display adapter (GPU) 20 to accelerate processor 12.

Memory 14 may include machine system readable medium in the form of volatile memory, such as random access memory (RAM), read only memory (ROM), and/or cache memory. Memory 14 is used to store one or more programs containing instructions and data. The processor 12 can read the instructions stored in the memory 14 to execute the above-mentioned method according to the embodiment of the present application.

computation device 30 may also communicate with one or more networks through network interface 16. The network interface 16 may be a wireless network interface.

The bus 22 may include an address bus, a data bus, a control bus, etc. Bus 22 provides a path for exchanging information between components.

It should be noted that during specific implementation, computation device 30 may also include other components necessary for normal operation. In addition, those skilled in the art can understand that the above-mentioned device may only include components necessary to implement the embodiments of this disclosure, and does not necessarily include all components shown in the drawings.

The present application also provides a computer-readable storage medium on which a computer program is stored, which implements the steps of the above method when executed by a processor. Computer-readable storage medium may include, but is not limited to, any type of disk, including floppy disks, optical disks, DVDs, CD-ROMs, microdrives, and magneto-optical disks, ROM, RAM, EPROM, EEPROM, DRAM, VRAM, flash memory devices, magnetic cards or optical cards, nanosystems (including molecular memory ICs), network storage devices, cloud storage devices, or any type of medium or device suitable for storing instructions and/or data.

Embodiments of the present application also provide a computer program product. The computer program product includes a non-transitory computer-readable storage medium that stores a computer program. The computer program is operable to cause the computer to execute some or all steps of any of the methods described in the above method embodiments.

Those skilled in the art can clearly understand that the technical solution of the present application can be implemented by means of software and/or hardware. “Unit” and “module” in this disclosure refer to software and/or hardware that can complete specific functions independently or in cooperation with other components. The hardware can be, for example, a field programmable gate array, an integrated circuit, etc.

It should be noted that for the sake of simple description, the foregoing method embodiments are expressed as a series of action combinations. However, those skilled in the art should know that the present application is not limited by the described action sequence. Because in accordance with this application, certain steps may be performed in other orders or simultaneously. Secondly, those skilled in the art should also know that the embodiments described in the disclosure are preferred embodiments, and the actions and modules involved are not necessarily required for this application.

Each of the above embodiments is described with its own emphasis. For parts not detailed in a certain embodiment, please refer to the relevant descriptions in other embodiments.

In the several embodiments provided in the present application, it should be understood that the disclosed device can be implemented in other ways. For example, the device embodiments described above are only illustrative. For example, the division of units is only a logical function division. In actual implementation, there may be other division methods. For example, multiple units or components may be combined or integrated into another system, or some features can be ignored, or not implemented. On the other hand, the coupling or direct coupling or communication connection between each other shown or discussed may be implemented through some service interfaces, and the indirect coupling or communication connection of the devices or units may be in electrical or other forms.

A unit described as a separate component may or may not be physically separate. A component shown as a unit may or may not be a physical unit, that is, it may be located in one place, or it may be distributed to multiple network units. Some or all of the units can be selected according to actual needs to achieve the purpose of the solution of this embodiment.

In addition, each functional unit in each embodiment of the present application can be integrated into one processing unit, each unit can exist physically alone, or two or more units can be integrated into one unit. The above integrated units can be implemented in the form of hardware or software functional units.

Integrated units may be stored in a computer-readable memory when implemented as software functional units and sold or used as independent products. Based on this understanding, the technical solution of the present application can be embodied in the form of software product in essence or in the part that contributes to the existing technology or in all or part of the technical solution, and the computer software product is stored in a memory, which includes several instructions to cause a computer device (which can be a personal computer, a server or a network device, etc.) to execute all or part of the steps of the methods of various embodiments of the present application.

Each of the above embodiments is described with its own emphasis. For parts not detailed in a certain embodiment, please refer to the relevant descriptions in other embodiments.

Exemplary embodiments of the present application have been specifically shown and described above. It is to be understood that the present application is not limited to the detailed structures, arrangements, or implementation methods described herein. On the contrary, the present application is intended to cover various modifications and equivalent arrangements included within the spirit and scope of the appended terms.

What is claimed is:

1. An addition tree computation device, used for an addition operation of floating-point numbers and fixed-point numbers, characterized in that
the addition tree computation device comprises a data input module, a first multiplexer, a transmission control module, a fusion calculation module, and a data normalization output module; the fusion calculation module has a first entrance and a second entrance, wherein:
the data input module receives an input data and a calculation type instruction;
the transmission control module controls the first multiplexer according to the calculation type instruction to send a floating-point number to the first entrance of the fusion calculation module, or to send a fixed-point number to the second entrance of the fusion calculation module;
the fusion calculation module is used to perform a fixed-point number addition operation and a floating-point number addition operation, and output an operation result to the data normalization output module; and
the transmission control module controls the data normalization output module to perform an output processing on the operation result according to the calculation type instruction, and outputs a final calculation result.

2. The addition tree computation device according to claim 1, characterized in that
the fusion calculation module comprises a preprocessing module, a second multiplexer and a fixed-point addition tree module, wherein:
the preprocessing module receives the floating-point number through the first entrance and sends a preprocessing result to the second multiplexer;
the second multiplexer receives the fixed-point number from the first multiplexer through the second entrance, and outputs the fixed-point number or the preprocessing result according to control of the transmission control module; and
the fixed-point addition tree module receives the output of the second multiplexer to perform a fixed-point addition operation.

3. The addition tree computation device according to claim 2, characterized in that the preprocessing module comprises an exponent difference module, a mantissa alignment module and an exponent register array, wherein:
the exponent difference module is used to calculate an exponent difference between an input floating-point number and a floating-point number reference exponent;
the mantissa alignment module applies a calculated exponent difference to shift a mantissa of the floating-point number;
the exponent register array is used to store the floating-point number reference exponent, the floating-point number reference exponent is obtained by performing an exponent comparison on the input floating-point number through the exponent difference module or is preset.

4. The addition tree computation device according to claim 3, characterized in that the data normalization output module comprises: a third multiplexer, a normalization processing unit, and a fourth multiplexer, wherein:
the third multiplexer sends the operation result of the fusion calculation module to the normalization processing unit or the fourth multiplexer according to the control of the transmission control module;
the normalization processing unit is used to perform a normalization operation on an input operation result according to a floating-point number specification, and send a normalized result data to the fourth multiplexer;
the fourth multiplexer outputs the final calculation result according to the control of the transmission control module.

5. The addition tree computation device according to claim 4, characterized in that the normalization processing unit is configured to:
read the floating-point number reference exponent stored in the exponent register array, perform data normalization and rounding processing on a floating-point addition operation result, and output the floating-point number that meets the specification.

6. A method for an addition tree computation device to implement an addition operation of floating-point numbers and fixed-point numbers, characterized in that the method comprises:
receiving an input data which is a fixed-point number or a floating-point number;
sending the floating-point number to a first calculation channel;
sending a fixed-point number data to a second calculation channel;
performing a fixed-point addition operation on the input data from the first calculation channel or the second calculation channel; and
performing an output processing on an operation result according to a data type.

7. The method according to claim 6, characterized in that
the step of sending the floating-point number to a first calculation channel further comprises:
for an input floating-point number, calculating an exponent difference of each floating-point number according to a floating-point number reference exponent which is obtained by performing an exponent comparison on the input floating-point number or is preset;
shifting a mantissa of the floating-point number according to the exponent difference of each floating-point number.

8. The method according to claim 7, characterized in that
the step of performing a fixed-point addition operation on the input data from the first calculation channel or the second calculation channel comprises:
receiving the floating-point number and/or the fixed-point number after the mantissa is shifted and sending the floating-point number and/or the fixed-point number to a fixed-point addition tree;
using the fixed-point addition tree to perform the addition operation to obtain the operation result.

9. The method according to claim 6, characterized in that
the step of performing an output processing on an operation result according to a data type comprises:
in response to the operation result being the floating-point number, performing a normalization processing on the operation result to output a normalized result data as a final calculation result;
in response to the operation result being the fixed-point number data, outputting the operation result as the final calculation result.

10. A computation device, characterized by comprising:
a processor; and
a memory storing a computer program that, when executed by the processor, causes the processor to execute the method according to claim 6.

11. A computation device, characterized by comprising:
a processor; and
a memory storing a computer program that, when executed by the processor, causes the processor to execute the method according to claim 7.

12. A computation device, characterized by comprising:
a processor; and
a memory storing a computer program that, when executed by the processor, causes the processor to execute the method according to claim 8.

13. A computation device, characterized by comprising:
a processor; and
a memory storing a computer program that, when executed by the processor, causes the processor to execute the method according to claim 9.
